(19) United States
(12) Patent Application Publication
(10) Pub. No.: US 2025/0286087 A1
(43) Pub. Date: Sep. 11, 2025

(54) FUEL CELL COOLING SYSTEM

(71) Applicant: TOYOTA JIDOSHA KABUSHIKI KAISHA, Toyota-shi (JP)

(72) Inventor: Hiromichi SATO, Hadano-shi (JP)

(73) Assignee: TOYOTA JIDOSHA KABUSHIK] KAISHA, Toyota-shi (JP)

(21) Appl. No.: 18/968,800

(22) Filed: Dec. 4, 2024

(30) Foreign Application Priority Data
Mar. 5, 2024 (JP) 2024-032832

(51) Int. Cl. H01M 8/04007; H01M 8/0432; H01M 8/04701

(52) U.S. Cl. CPC H01M 8/04074; H01M 8/04358; H01M 8/04731

(57) ABSTRACT

The fuel cell cooling system includes first and second cooling flow paths, a fuel cell, an ion exchanger, a radiator, and an intermediate heat exchanger. When the temperature of the refrigerant in the first cooling flow path is lower than a reference value during power generation of the fuel cell, a first operation is performed to circulate the refrigerant in the first cooling flow path along a route in which the refrigerant that has passed through the intermediate heat exchanger flows through the fuel cell and the ion exchanger in parallel and circulate the refrigerant in the second cooling flow path along a route in which the refrigerant passes through the intermediate heat exchanger and the radiator, and when the temperature of the refrigerant in the first cooling flow path is higher than the reference value during the power generation in the fuel cell, a second operation is performed.

### CROSS-REFERENCE TO RELATED APPLICATION

This application claims priority to Japanese Patent Application No. 2024-032832 filed on Mar. 5, 2024, incorporated herein by reference in its entirety.

### BACKGROUND

### 1. Technical Field

The technology disclosed herein relates to a fuel cell cooling system.

### 2. Description of Related Art

A fuel cell system disclosed in Japanese Unexamined Patent Application Publication No. 2002-33108 (JP 2002-33108 A) has a first cooling flow path and a second cooling flow path for circulating a refrigerant. A fuel cell is provided in the first cooling flow path. A radiator is provided in the second cooling flow path. An intermediate heat exchanger is provided across the first cooling flow path and the second cooling flow path. The intermediate heat exchanger exchanges heat between the first cooling flow path and the second cooling flow path.

### SUMMARY

In the fuel cell system, an ion exchanger may be provided to remove ions from the refrigerant flowing through the cooling flow path. In the technology of JP 2002-33108 A, when the ion exchanger is provided in the first cooling flow path, a high-temperature refrigerant flows into the ion exchanger, and the ion exchanger may deteriorate. The present specification proposes a technology for suppressing thermal deterioration of an ion exchanger.

### First Aspect

A fuel cell cooling system disclosed herein includes:
a first cooling flow path through which a refrigerant circulates;
a fuel cell provided in the first cooling flow path;
an ion exchanger provided in the first cooling flow path;
a second cooling flow path through which a refrigerant circulates;
a radiator provided in the second cooling flow path; and
an intermediate heat exchanger configured to perform heat exchange between the first cooling flow path and the second cooling flow path.

When a temperature of the refrigerant in the first cooling flow path is lower than a reference value during power generation in the fuel cell, a first operation is performed to circulate the refrigerant in the first cooling flow path along a route in which the refrigerant that has passed through the intermediate heat exchanger flows through the fuel cell and the ion exchanger in parallel and circulate the refrigerant in the second cooling flow path along a route in which the refrigerant passes through the intermediate heat exchanger and the radiator. When the temperature of the refrigerant in the first cooling flow path is higher than the reference value during the power generation in the fuel cell, a second operation is performed to circulate the refrigerant in the first cooling flow path along a route in which the refrigerant passes through the intermediate heat exchanger and the fuel cell while a flow path of the ion exchanger is closed and circulate the refrigerant in the second cooling flow path along the route in which the refrigerant passes through the intermediate heat exchanger and the radiator.

In the fuel cell cooling system described above, when the temperature of the refrigerant in the first cooling flow path is higher than the reference value during the power generation in the fuel cell, the second operation is performed. In the second operation, the refrigerant circulates in the first cooling flow path along the route in which the refrigerant passes through the intermediate heat exchanger and the fuel cell while the flow path of the ion exchanger is closed. That is, the high-temperature refrigerant does not flow into the ion exchanger. As a result, thermal deterioration of the ion exchanger can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a fuel cell cooling system of Example 1;

FIG. 2 is a flowchart of an operation selection process of the fuel cell cooling system according to the first embodiment;

FIG. 3 is a block-diagram of a fuel cell cooling system according to a second embodiment; and

FIG. 4 is a flowchart of an operation selection process of the fuel cell cooling system according to the second embodiment.

### DETAILED DESCRIPTION OF EMBODIMENTS

Following the above first aspect, additional configurations of the fuel cell cooling system disclosed herein are described below.

### Second Aspect

The fuel cell cooling system according to the first aspect, wherein the temperature of the reference value is 75° C. or higher.

### Third Aspect

In the in the fuel cell cooling system according to the first or second aspect, when the temperature of the refrigerant in the first cooling flow path is higher than the reference value and the conductivity of the refrigerant in the first cooling flow path is higher than a threshold value, the first operation is performed.

### Fourth Aspect

The fuel cell cooling system according to any one of the first to third aspects, wherein the first cooling flow path comprises:
A fuel cell flow path provided with the fuel cell,
An ion exchanger flow path provided with the ion exchanger,
An intermediate heat exchanger flow path provided with the intermediate heat exchanger, wherein
A downstream end of the intermediate heat exchanger flow path is connected to an upstream end of the ion exchanger flow path and an upstream end of the fuel cell flow path, an upstream end of the intermediate heat exchanger flow path is connected to a downstream end of the ion exchanger flow path and a downstream end of the fuel cell flow path, and has a pump provided in the intermediate heat exchanger flow path.

According to the second aspect, deterioration of the resin of the ion exchanger can be suppressed.

According to the third aspect, even if the temperature of the refrigerant in the first cooling flow path is high, if the conductivity of the first cooling flow path is high, the refrigerant in the first cooling flow path is caused to flow into the ion exchanger. As a result, it is possible to suppress the increase in the conductivity of the refrigerant while minimizing the thermal deterioration of the ion exchanger.

According to the fourth aspect, since the refrigerant cooled by the intermediate heat exchanger flows into the ion exchanger, it is possible to more effectively suppress the thermal deterioration of the ion exchanger.

### First Embodiment

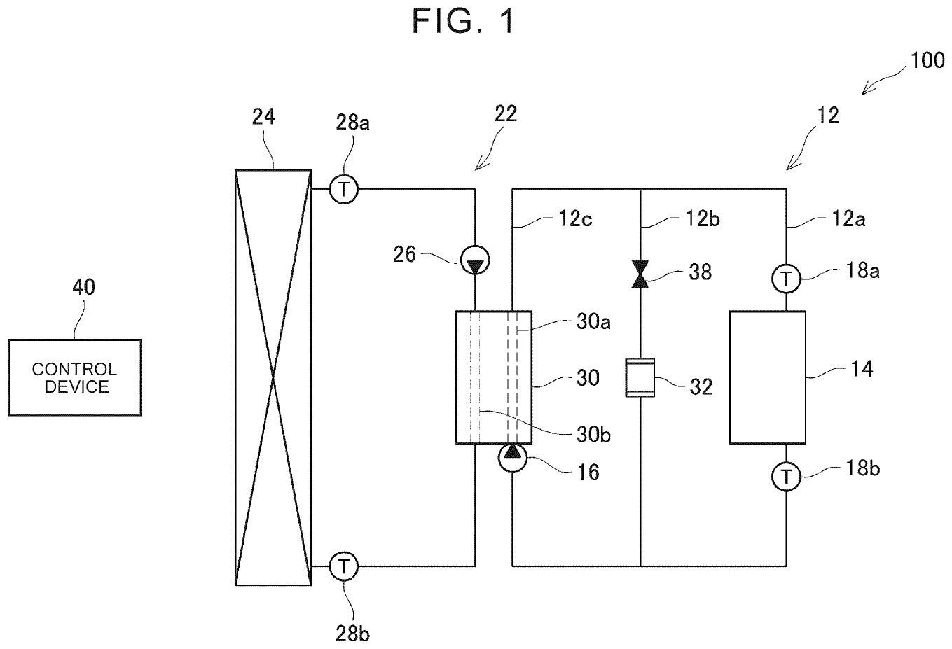

The fuel cell cooling system of the first embodiment will be described. The fuel cell cooling system 100 shown in FIG. 1 is mounted on a device (for example, a fuel cell electric vehicle) using a fuel cell as a power source. The fuel cell cooling system 100 includes a first cooling flow path 12, a second cooling flow path 22, an intermediate heat exchanger 30, a fuel cell 14, an ion exchanger 32, and a radiator 24.

The intermediate heat exchanger 30 has a first heat exchanger flow path 30a and a second heat exchanger flow path 30b. The first heat exchanger flow path 30a is a part of the first cooling flow path 12, and the second heat exchanger flow path 30b is a part of the second cooling flow path 22. The intermediate heat exchanger 30 causes heat exchange between the first heat exchanger flow path 30a and the second heat exchanger flow path 30b. That is, the intermediate heat exchanger 30 causes heat exchange between the first cooling flow path 12 and the second cooling flow path 22.

The first cooling flow path 12 includes a fuel cell flow path 12a, an ion exchanger flow path 12b, and an intermediate heat exchanger flow path 12c. A fuel cell 14 is provided in the fuel cell flow path 12a. An ion exchanger 32 is provided in the ion exchanger flow path 12b. An intermediate heat exchanger 30 is provided in the intermediate heat exchanger flow path 12c. Part of the intermediate heat exchanger flow path 12c is constituted by the first heat exchanger flow path 30a of the intermediate heat exchanger 30. The downstream end of the intermediate heat exchanger flow path 12c is connected to the upstream end of the ion exchanger flow path 12b and the upstream end of the fuel cell flow path 12a. Further, the upstream end of the intermediate heat exchanger flow path 12c is connected to the downstream end of the ion exchanger flow path 12b and the downstream end of the fuel cell flow path 12a. A pump 16 is provided in the intermediate heat exchanger flow path 12c. The pump 16 feeds the refrigerant from the installation position toward the intermediate heat exchanger 30. When the pump 16 is operated, the refrigerant circulates in the first cooling flow path 12. The coolant that has passed through the intermediate heat exchanger flow path 12c flows in parallel to the ion exchanger flow path 12b and the fuel cell flow path 12a.

The fuel cell 14 is supplied with compressed air from an air compressor (not shown) and hydrogen from a tank (not shown). The fuel cell 14 generates electric power by reacting oxygen with hydrogen, and supplies electric power to a motor (not shown). The fuel cell 14 is cooled by the coolant flowing in the fuel cell flow path 12a.

The ion exchanger 32 removes ions from the coolant flowing in the ion exchanger flow path 12b. The ion exchanger 32 lowers the conductivity of the refrigerant by lowering the ion concentration in the refrigerant.

A valve 38 is provided in the ion exchanger flow path 12b. The valve 38 is provided between the upstream end of the ion exchanger flow path 12b and the ion exchanger 32. The valve 38 opens and closes the flow path of the ion exchanger flow path 12b. When the valve 38 is open, the coolant that has passed through the intermediate heat exchanger 30 flows in parallel to the ion exchanger flow path 12b and the fuel cell flow path 12a. In addition, when the valve 38 is closed, the coolant that has passed through the intermediate 20 heat exchanger 30 does not flow to the ion exchanger flow path 12b but flows to the fuel cell flow path 12a.

The fuel cell cooling system 100 includes temperature sensors 18a, 18b. The temperature sensor 18a is provided upstream of the fuel cell flow path 12a. The temperature sensor 18a detects the temperature of the coolant flowing into the fuel cell 14 (hereinafter referred to as FC inlet temperature). The temperature sensor 18b is provided downstream of the fuel cell flow path 12a. The temperature sensor 18b detects the temperature of the coolant discharged from the fuel cell 14.

The second cooling flow path 22 is an annular flow path. The radiator 24 is provided in the second cooling flow path 22. The radiator 24 cools the refrigerant flowing through the second cooling flow path 22 by heat exchange with the outside air. In addition, an intermediate heat exchanger 30 is provided in the second cooling flow path 22. A part of the second cooling flow path 22 is constituted by the second heat exchanger flow path 30b of the intermediate heat exchanger 30.

The fuel cell cooling system 100 includes a pump 26, a temperature sensor 28a, and a temperature sensor 28b.

The pump 26 is provided in the second cooling flow path 22. The pump 26 delivers the refrigerant from the installation position toward the intermediate heat exchanger 30. When the pump 26 is operated, the refrigerant circulates in the second cooling flow path 22.

The temperature sensor 28a is provided downstream of the radiator 24 in the second cooling flow path 22. The temperature sensor 28a detects the temperature of the coolant emitted from the radiator 24. The temperature sensor 28b is provided in the second cooling flow path 22 upstream of the radiator 24. The temperature sensor 28b detects the temperature of the coolant flowing into the radiator 24.

The fuel cell cooling system 100 includes a control device 40. The control device 40 controls the pump 16, the pump 26, and the valve 38 based on the temperature of the refrigerant in the first cooling flow path 12.

When the fuel cell 14 generates electricity, the fuel cell 14 generates heat. The control device 40 activates the pumps 16, 26 during power generation of the fuel cell 14. When the pump 16 is operated, the refrigerant circulates in the first cooling flow path 12. When the pump 26 is operated, the refrigerant circulates in the second cooling flow path 22. The fuel cell 14 is cooled by heat exchange between the refrigerant in the first cooling flow path 12 and the fuel cell 14. The heat generated by the power generation of the fuel cell 14 is transferred to the intermediate heat exchanger 30 (that is, the first heat exchanger flow path 30a) by the coolant in the first cooling flow path 12. The intermediate heat exchanger 30 transfers the heat generated by the power generation of the fuel cell 14 from the first heat exchanger flow path 30a to the second heat exchanger flow path 30b. Heat is transferred from the intermediate heat exchanger 30 to the radiator 24 by the refrigerant in the second cooling flow path 22. The refrigerant in the second cooling flow path 22 is cooled by the radiator 24 performing heat exchange with the outside air.

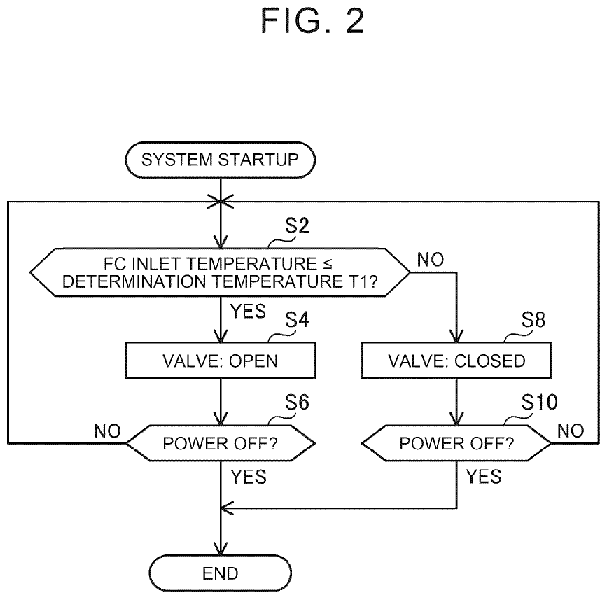

The fuel cell cooling system 100 controls the valve 38 according to the flowchart shown in FIG. 2 during power generation of the fuel cell 14.

In S2, the control device 40 determines whether FC inlet temperature is equal to or lower than the determination temperature T1. The determination temperature T1 is set to a temperature (for example, 75° C. or higher) at which the performance of the ion exchanger 32 can be ensured. As the determination temperature T1, for example, the degradation-onset temperature of the resin in the ion exchanger 32 can be adopted.

If FC inlet temperature is less than or equal to the determination temperature T1 (S2 is YES), the control device 40 brings the valve 38 into an open state (S4). When the valve 38 is opened, the refrigerant that has passed through the intermediate heat exchanger 30 flows in parallel to the ion exchanger 32 and the fuel cell 14 in the first cooling flow path 12. In this case, since the temperature of the refrigerant in the first cooling flow path 12 is low, the low-temperature refrigerant flows into the ion exchanger 32. Therefore, in the ion exchanger 32, deterioration due to heat of the flowing refrigerant is less likely to occur. In particular, since the low-temperature refrigerant immediately after passing through the intermediate heat exchanger 30 flows into the ion exchanger 32, the thermal deterioration of the ion exchanger 32 can be effectively suppressed. In addition, when the determination temperature T1 is set to the deterioration starting temperature of the resin, the deterioration of the resin in the ion exchanger 32 can be effectively suppressed. When the refrigerant flows into the ion exchanger 32, the ion exchanger 32 removes ions from the refrigerant. As a result, the ion concentration in the refrigerant decreases, and the conductivity of the refrigerant decreases. Further, the fuel cell 14 is efficiently cooled by the inflowing refrigerant.

The control device 40 repeatedly executes S6 from S2 while FC inlet temperature is equal to or lower than the determination temperature T1. Therefore, while FC inlet temperature is equal to or lower than the determination temperature T1, the control device 40 opens the valve 38 until the power of the vehicle is turned OFF.

If FC inlet temperature exceeds the determination temperature T1 (NO at S2), the control device 40 brings the valve 38 into a closed state (S8). When the valve 38 is closed, the refrigerant that has passed through the intermediate heat exchanger 30 does not flow to the ion exchanger 32 in the first cooling flow path 12. Therefore, in the first cooling flow path 12, the refrigerant circulates through the intermediate heat exchanger 30 and the fuel cell 14. In this way, when the temperature of the refrigerant in the first cooling flow path 12 is high, the valve 38 is closed to prevent the high-temperature refrigerant from flowing into the ion exchanger 32. Therefore, in the ion exchanger 32, deterioration due to heat of the refrigerant is less likely to occur. Further, the fuel cell 14 is cooled by a refrigerant.

The control device 40 repeatedly executes S2, S8, S10 while FC inlet temperature exceeds the determination temperature T1. Thus, while FC inlet temperature exceeds the determination temperature T1, the control device 40 closes the valve 38 until the vehicle is powered OFF.

As described above, in the first embodiment, the control device 40 closes the valve 38 when FC inlet temperature is high, thereby reducing the high-temperature coolant from flowing into the ion exchanger 32. Therefore, deterioration of the ion exchanger 32 can be suppressed.

### Second Embodiment

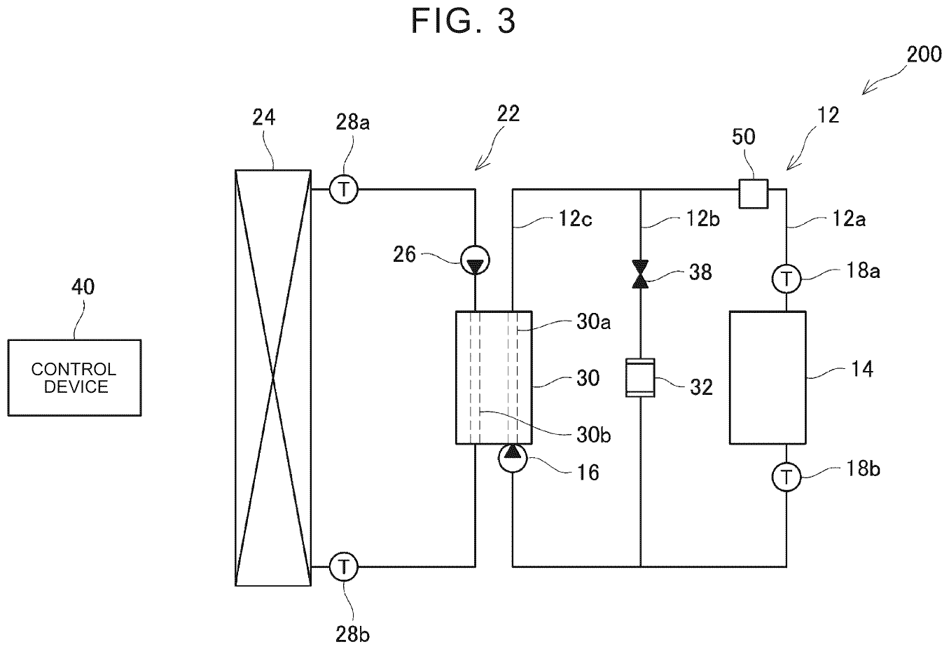

The fuel cell cooling system of the second embodiment will be described. As shown in FIG. 3, the fuel cell cooling system 200 of the second embodiment has a configuration in which a conductivity meter 50 is added to the fuel cell cooling system 100 of the first embodiment. The conductivity meter 50 measures the conductivity C2 of the coolant flowing through the first cooling flow path 12.

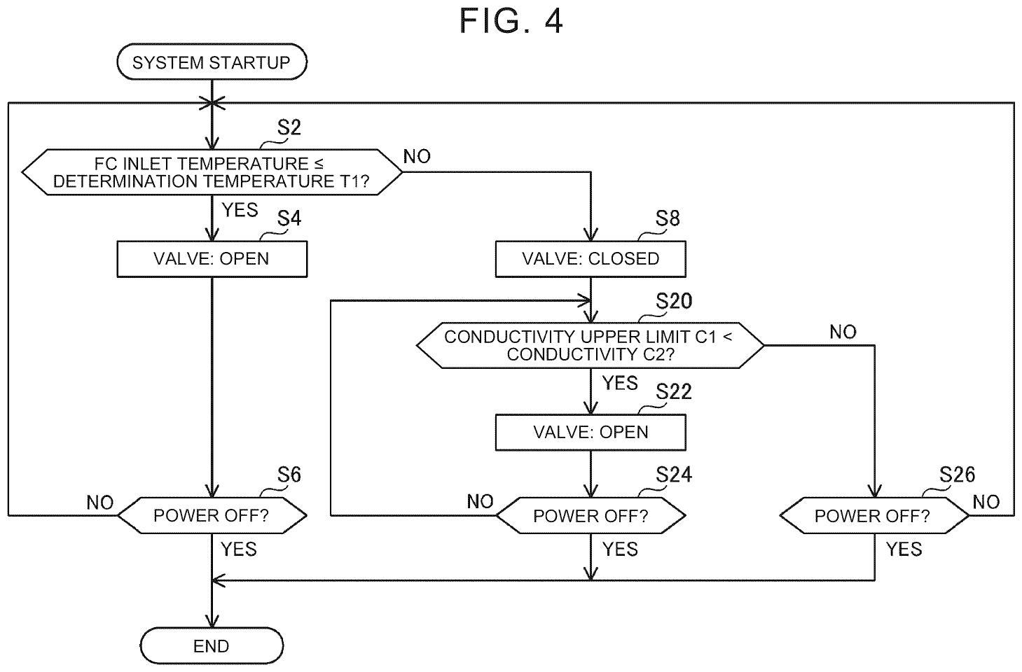

The fuel cell cooling system 200 controls the valve 38 according to the flowchart shown in FIG. 4 during power generation of the fuel cell 14. S2, S4, S6 and S8 shown in FIG. 4 are the same as S2, S4, S6 and S8 shown in FIG. 2.

In the second embodiment, after S8 is performed, the control device 40 determines whether the conductivity C2 exceeds the conductivity upper limit C1 in S20.

If the conductivity C2 exceeds the conductivity upper limit C1 (S20 and YES), the control device 40 brings the valve 38 into an open state (S22). When the valve 38 is opened, the refrigerant that has passed through the intermediate heat exchanger 30 flows in parallel to the ion exchanger 32 and the fuel cell 14 in the first cooling flow path 12. When the refrigerant flows into the ion exchanger 32, the ion exchanger 32 removes ions from the refrigerant. Accordingly, the ion concentration in the refrigerant can be reduced. As a consequence, the conductivity C2 of the coolant flowing in the first cooling flow path 12 decreases.

The control device 40 repeatedly executes S24 from S20 while the conductivity C2 exceeds the conductivity upper limit C1. Thus, while the conductivity C2 exceeds the conductivity upper limit C1, the control device 40 opens the valve 38 until the vehicle is powered OFF. This lowers the conductivity C2.

If the conductivity C2 is less than the conductivity upper limit C1 (NO by S20), the control device 40 keeps the valve 38 closed. Therefore, in the first cooling flow path 12, the refrigerant that has passed through the intermediate heat exchanger 30 does not flow to the ion exchanger 32. Therefore, in the first cooling flow path 12, the refrigerant circulates through the intermediate heat exchanger 30 and the fuel cell 14. As described above, when the temperature of the refrigerant in the first cooling flow path 12 is high and the conductivity C2 is less than the conductivity upper limit C1, the control device 40 reduces the high-temperature refrigerant from flowing into the ion exchanger 32 by closing the valve 38. Therefore, in the ion exchanger 32, deterioration due to heat of the refrigerant is less likely to occur. The control device 40 repeatedly executes S2, S8, S20 and S26 while the conductivity C2 is less than the conductivity upper limit C1. Therefore, while the conductivity C2 is less than the conductivity upper limit C1, the control device 40 closes the valve 38 until the power of the vehicle is turned OFF.

As described above, in the second embodiment, the control device 40 opens the valve 38 when the conductivity C2 of the refrigerant in the first cooling flow path 12 is higher even when the temperature of the refrigerant in the first cooling flow path 12 is high. Thus, the conductivity C2 of the coolant flowing in the first cooling flow path 12 can be suppressed from becoming excessively high.

In first and second embodiments, the flow path changing device for changing the flow path of the refrigerant in the first cooling flow path 12 by the valve 38 is configured, the flow path changing device may be configured by other devices (for example, a three-way valve or the like). Further, in the first embodiment, the valve 38 is a solenoid valve, but a flow path changing device may be configured by a device that does not use electricity. For example, a flow path changing device may be configured by a device that switches a flow path by thermal expansion of a material, such as a thermostat.

The process of opening the valve 38 of the first and second embodiments is an example of the first operation. The process of closing the valve 38 of the first and second embodiments is an example of the second operation.

The determination temperature T1 of the first and second embodiments are examples of reference values. The conductivity upper limit C1 of the second embodiment is an example of thresholds.

While the embodiments have been described in detail above, these are merely illustrative and do not limit the scope of the claims. The technology described in the claims includes various modifications and alterations of the specific examples described above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

What is claimed is:

1. A fuel cell cooling system comprising:
a first cooling flow path through which a refrigerant circulates;
a fuel cell provided in the first cooling flow path;
an ion exchanger provided in the first cooling flow path;
a second cooling flow path through which a refrigerant circulates;
a radiator provided in the second cooling flow path; and
an intermediate heat exchanger configured to perform heat exchange between the first cooling flow path and the second cooling flow path, wherein
when a temperature of the refrigerant in the first cooling flow path is lower than a reference value during power generation in the fuel cell, a first operation is performed to circulate the refrigerant in the first cooling flow path along a route in which the refrigerant that has passed through the intermediate heat exchanger flows through the fuel cell and the ion exchanger in parallel and circulate the refrigerant in the second cooling flow path along a route in which the refrigerant passes through the intermediate heat exchanger and the radiator, and
when the temperature of the refrigerant in the first cooling flow path is higher than the reference value during the power generation in the fuel cell, a second operation is performed to circulate the refrigerant in the first cooling flow path along a route in which the refrigerant passes through the intermediate heat exchanger and the fuel cell while a flow path of the ion exchanger is closed and circulate the refrigerant in the second cooling flow path along the route in which the refrigerant passes through the intermediate heat exchanger and the radiator.

2. The fuel cell cooling system according to claim 1, wherein the reference value is 75° C. or higher.

3. The fuel cell cooling system according to claim 1, wherein the first operation is performed when the temperature of the refrigerant in the first cooling flow path is higher than the reference value and conductivity of the refrigerant in the first cooling flow path is higher than a threshold value.

4. The fuel cell cooling system according to claim 1, wherein:
the first cooling flow path includes:
a fuel cell flow path provided with the fuel cell;
an ion exchanger flow path provided with the ion exchanger; and
an intermediate heat exchanger flow path provided with the intermediate heat exchanger;
a downstream end of the intermediate heat exchanger flow path is connected to an upstream end of the ion exchanger flow path and an upstream end of the fuel cell flow path;
an upstream end of the intermediate heat exchanger flow path is connected to a downstream end of the ion exchanger flow path and a downstream end of the fuel cell flow path; and
a pump is provided in the intermediate heat exchanger flow path.
